(19) United States
(12) Patent Application Publication
(10) Pub. No.: US 2017/0060911 A1
(43) Pub. Date: Mar. 2, 2017

(54) Systems and Methods For an Open System Internet of Things Data Hub

(71) Applicant: Synchronoss Technologies, Inc., Bridgewater, NJ (US)

(72) Inventor: Thomas P. Loscalzo, Stewartsville, NJ (US)

(21) Appl. No.: 15/253,744

(22) Filed: Aug. 31, 2016

Related U.S. Application Data
(60) Provisional application No. 62/212,098, filed on Aug. 31, 2015.

(51) Int. Cl. G06F 17/30

(52) U.S. Cl. CPC G06F 17/30297; G06F 17/30554; G06F 17/30589; G06F 17/30569

(57) ABSTRACT

A method for storing and accessing data in an open system Internet of Things (IoT) data hub is disclosed. The method comprises receiving a request to aggregate data from at least two devices; for each device: obtaining data according to a closed data schema; identifying a standard data schema defined for a device type from which the data was obtained; executing a translator to transform the obtained data to be in conformity to the identified standard schema; and storing the transformed data in a data structure in a memory accessible by a plurality of applications; retrieving a plurality of elements from the data structure, wherein at least one element from the plurality of elements was obtained from each of the plurality of devices; executing a set of instructions to aggregate the retrieved plurality of elements; and providing the aggregated elements for display.

### CROSS-REFERENCE TO RELATED APPLICATIONS

This application claims benefit of U.S. Provisional Patent Application Ser. No. 62/212,098, filed Aug. 31, 2015, which is herein incorporated by reference in its entirety.

### BACKGROUND

Field

Embodiments consistent with the present invention generally relate to the Internet of Things (IoT) and more specifically, to a system and method for an open system IoT data hub.

Description of the Related Art

The Internet of Things (IoT) is the network of physical devices, vehicles, buildings, etc. embedded with electronics, software, sensors, and network connectivity that enables these objects to collect and exchange data. The IoT allows objects to be sensed and controlled remotely across existing network infrastructure, creating opportunities for more direct integration of the physical world into computer-based systems.

Currently, IoT platforms are closed systems, meaning that each device manufacturer defines its own data schema (i.e., closed schema) for the data it retrieves from the manufacturer's devices. In other words, how the device manufacturer names and structures its data is proprietary to the device manufacturer. Other devices in the system may be able to interact with the manufacturer's devices using open Application Programming Interface (API) calls to a manufacturer's server.

Some manufactures make agreements with one another to share data. For example, a fitness tracking device manufacturer may have an agreement with the developer of a nutrition application, or app. Such an agreement would allow access to each other's data schemas thereby enabling the nutrition app to understand and display the fitness tracking data within the nutrition app and/or have the fitness tracking app understand the nutrition data such that it can be displayed on the fitness tracker's website. Alternately, if a manufacturer exposes APIs to access their data, a third-party developer is able to develop a dashboard app that aggregates the data by using the APIs to access user data from both the fitness tracking device as well as the nutrition app to combine the data in a single display. As such, a user can only see a dashboard of his or her aggregated data from the user device when manufacturers make agreements with one another or when manufacturers provide a way to access the data and a developer writes an app specifically to combine the user's data. The data from each manufacturer that does not make agreements with other manufacturers or expose their APIs, must be viewed by the user in each manufacturer's app. Therefore, a user will need to view their data separately in hundreds of apps instead of just one. This is a poor user experience.

For an app developer, these closed systems require a significant amount of labor. As a simplified example, if there are five manufacturers and five dashboard developers, in order to accommodate every combination of manufacturer device data, each developer would need to write twenty-five dashboard app. In the coming years, there will be thousands of new manufacturers requiring millions of dashboard interfaces. This is expensive to the developers and creates redundancy of work, as each developer creates his or her own set of applications.

A need therefore exists for systems and methods for an open system IoT data hub.

### SUMMARY

A method and system for an open system IoT data hub are provided.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other and further embodiments of the present invention are described below.

Other and further embodiments of the present invention are described below.

### BRIEF DESCRIPTION OF THE DRAWINGS

So that the manner in which the above recited features of embodiments of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting a system configured for an open system IoT data hub, according to one or more embodiments of the invention;

FIG. 2 is a block diagram depicting an exemplary embodiment of an open system IoT data hub, according to one or more embodiments of the invention;

FIG. 3 depicts a flow diagram depicting a method for storing and accessing data in an open system IoT data hub, according to one or more embodiments;

FIG. 4 is a flow diagram of a method for retrieving data according to a closed schema and storing the data in a standardized form, in accordance with one or more embodiments of the present invention; and

FIG. 5 is a detailed block diagram of a computer system, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention include a system and method for an open system IoT data hub. Manufacturers that take part in the system may either participate by providing open schemas or alternatively, providing closed schemas with open APIs, while publishing the closed schemas to the IoT data hub. International industry organizations may participate by providing industry standard data schemas for devices. For example, an International Association of Thermostat Manufacturers may create standard schemas for reading from and writing to a thermostat. Manufacturers that take part in the system may either participate by providing schemas that comply with the standard schemas, or alternatively providing open schemas or closed schemas with open APIs, such that a translator may be built to convert the manufacturer's data to the industry standard schema. With the data in a standard form, developers may create applications to aggregate data retrieved from different devices with different closed schemas into a global view of a user's data.

For example, an athlete may use a first fitness tracking device that monitors heartrate, power, speed, distance, and location. The athlete may also use a second fitness tracking device that measures power in a way that is far superior to the first fitness tracking device. The athlete may also use a nutrition app to track his or her nutrition. As described in a previous example, in a closed system, the first fitness tracking device manufacturer may have an agreement with the developer of the nutrition app, such that data from the first fitness tracking device can be aggregated with the nutrition app and viewed using either the first fitness tracking device website, or a nutrition app website. However, because an agreement does not exist between the second fitness tracking device manufacturer and either of the first tracking device manufacturer or developer of the nutrition app, the aggregated results do not include the superior power measurements that are measured using the second fitness tracking device. Using the present invention of an open system IoT data hub, a developer may create an app that aggregates the data elements heartrate, speed, and distance from the first fitness tracking device, the power data element from the second fitness tracking device, and the nutrition data elements from the nutrition app onto a dashboard to provide a global view of the athlete's fitness. Further, with the global view, analytics may be included in the dashboard app that can determine whether the athlete is overtraining or at risk for injury. Instead of the athlete looking at the data and analysis on three or more apps, the open system IoT data hub encourages the participation of all device manufacturers such that all of the collected data can be provided to the athlete in one application.

Advantageously, an open system IoT data hub creates a financial incentive for manufacturers to conform to the system. When industries create standard schemas for reading from and writing to their devices, manufacturers that maintain closed schemas and closed APIs will be pushed out of the marketplace. Manufacturers that publish their schemas to the IoT data hub will interact with other manufacturer devices, websites, applications, and the like and create an enriched user experience.

Various embodiments of systems and methods for an open system IoT data hub are provided below. In the following detailed description, numerous specific details are set forth to provide a thorough understanding of the claimed subject matter. However, it will be understood by those skilled in the art that claimed subject matter may be practiced without these specific details.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

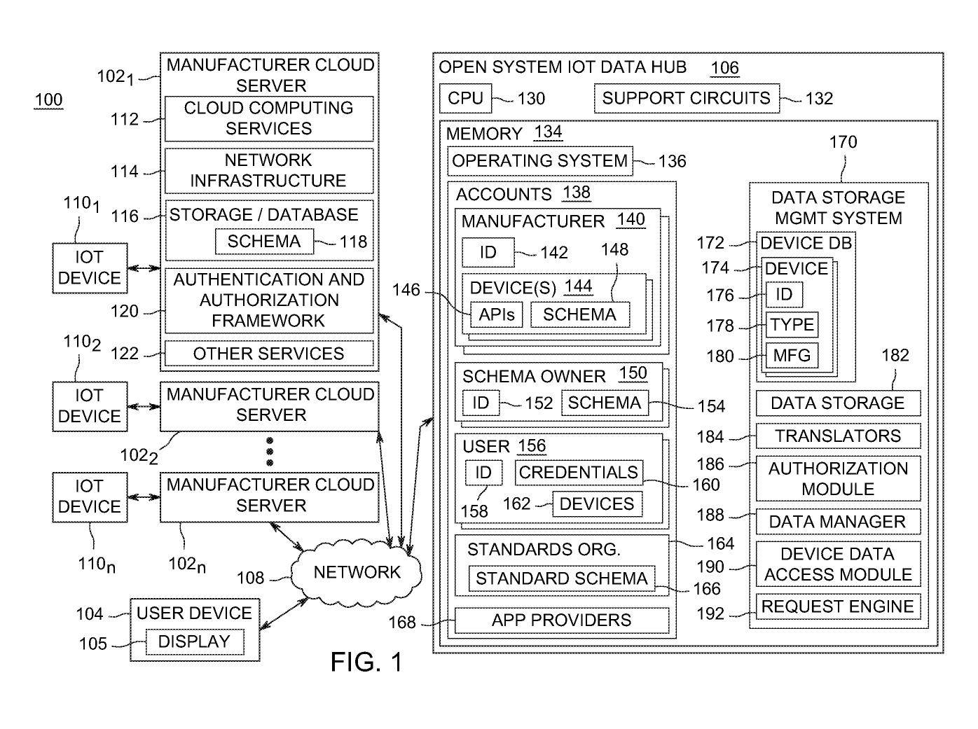

FIG. 1 is a block diagram depicting a system 100 configured for an open system IoT data hub, according to one or more embodiments of the invention. The various components of system 100 include a plurality of manufacturer cloud servers 102₁, 102₂, . . . , 102ₙ, (collectively referred to as manufacturer server 102), a plurality of IoT devices 110₁, 110₂, . . . , 110ₙ, (collectively referred to as IoT device 110), a user device 104 and an open system IoT data hub 106 (e.g., SYNCHRONOSS® Open System IoT data hub), communicatively connected via one or more network links. Some of the network links are established by a network 108, such as a Wide Area Network (WAN) or Metropolitan Area Network (MAN), which includes a communication system that connects computers (or devices) by wire, cable, fiber optic and/or wireless link facilitated by various types of well-known network elements, such as hubs, switches, routers, and the like. The network interconnecting some components may also be part of a Local Area Network (LAN) using various communications infrastructure, such as Ethernet, Wi-Fi, a personal area network (PAN), a wireless PAN, Bluetooth, Near field communication, and the like.

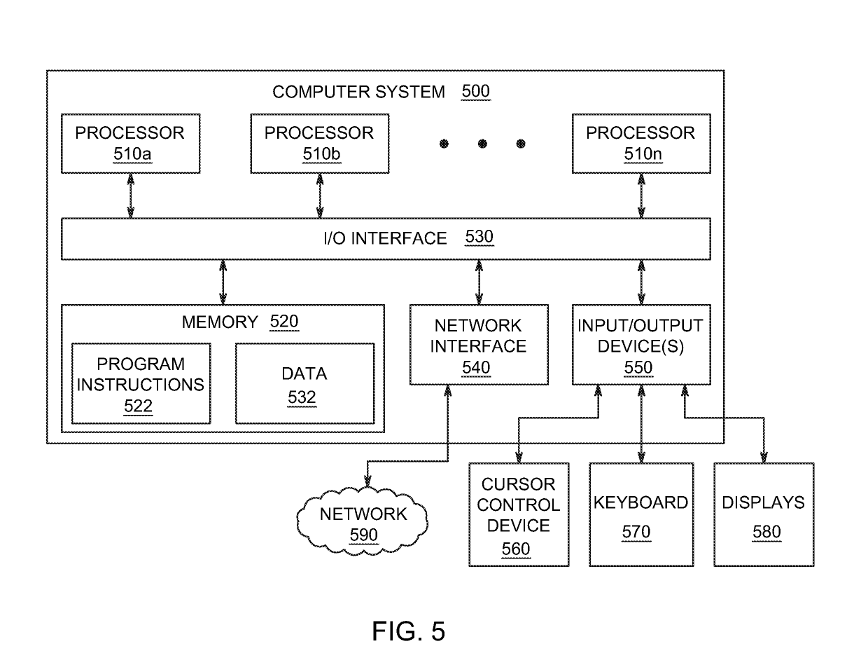

Each manufacturer cloud server 102 is a computing device, for example, a desktop computer, laptop, tablet computer, and the like, or it may be a cloud-based server e.g., a blade server, virtual machine, and the like. One example of a suitable computer is shown in FIG. 5, which will be described in detail below. According to some embodiments, each manufacturer cloud server 102 includes cloud computing services 112, a network infrastructure 114, a cloud storage database 116, an authentication and authorization framework 120, as well as other services 122 such as storing, accessing, consolidating, and manipulating data. Each manufacturer cloud server 102 has security models for users to create logins and passwords and to secure the user data based on these account credentials. The network infrastructure 114 includes one or more of the Internet, private network, mobile network connectivity, firewalls, routers, static or dynamic load balancers, encryption and decryption, key storage services, a Domain Name System (DNS), address translation services, redundancy services, backup services, disaster recovery service, point of presence and content caching services, and the like. The cloud storage database 116 may be any commercially available cloud storage or database including, but is not limited to relational databases, NoSQL databases, Time Series, Object, Sparse, distributed, streaming, file, block, bulk storage, and the like. The database 116 includes a data schema 118 that defines how the data is named and structured in the database 116. Other services 122 may include cloud billing and payment processing systems, cloud file, block, or bulk storage service, a cloud queuing service, a cloud notification service, and the like. Each manufacturer cloud server 102 provides services to an IoT device 110. For example, if the IoT device 110₁ is a GARMIN® Vivofit Fitness Band, the manufacturer cloud server 102₁ may be a GARMIN® server that collects and stores data recorded by and received from an app on a user's Fitness Band.

The user device 104 is a computing device, such as a smartphone, tablet, smartwatch, browser, desktop, laptop, wearable, automotive display, or the like. The user device 104 includes a display 105 for viewing data stored on the user's IoT devices 110 and later translated and stored on the Open System IoT Hub 106.

The Open System IoT Data Hub 106 comprises a plurality of accounts 138 and a data storage and management system 170. The Open System IoT Data Hub 106 is a computing device, for example, a desktop computer, laptop, tablet computer, and the like, or it may be a cloud based server e.g., a blade server, virtual machine, and the like. The Open System IoT Data Hub 106 includes a Central Processing Unit (CPU) 130, support circuits 132, and a memory 134. The CPU 130 may include one or more commercially available microprocessors or microcontrollers that facilitate data processing and storage. The various support circuits 132 facilitate the operation of the CPU 130 and include one or more clock circuits, power supplies, cache, input/output circuits, and the like. The memory 134 includes at least one of Read Only Memory (ROM), Random Access Memory (RAM), disk drive storage, optical storage, removable storage and/or the like.

The plurality of accounts 138 include manufacturer accounts 140, data schema owner accounts 150, user accounts 156, standard schema provider accounts 164, and app provider accounts 168. For each manufacturer account 140, a manufacturer identifier 142 in addition to one or more devices 144 that are manufactured are stored. Each device 144 includes APIs 146 for accessing data for the device 144 and a closed schema 148 for the data sent to and received from said device 144. By publishing the closed schema in the manufacturer account 140, the manufacturer may selectively interface with the IoT data hub 106. Each data schema owner account 150 includes a data schema owner identifier 152 and a schema 154. Each user account 156 includes a user identifier 158, credentials 160 for authorizing access to their data from the manufacturer cloud server 102, and one or more devices 162 from which their data is retrieved. Each standards organization includes a standard schema 166 to which all retrieved data may be translated for aggregation. App provider accounts 168 includes an account for a developer of each application that may use the data on the Open System IoT Data Hub 106.

A manufacturer may define one or more devices 144, one or more private schemas 148, create mappings between devices 144 and private schemas 148, and create version(s) of devices 144 and private schemas 148. A manufacturer may decide which devices 144 and schema 148 data the manufacturer chooses to make public and which devices 144 and schema 148 data are only accessible through the manufacturer account 140. When a manufacturer defines a schema 148, the manufacturer becomes a “schema owner” and their schema owner account 150 is linked to their manufacturer account 140. When a manufacturer writes apps (e.g., to translate, consolidate, manipulate, present in a dashboard, and the like) the manufacture also becomes an “app provider” and their app provider account 168 is linked to their manufacturer account 140. In some embodiments, a schema 154 defined by a schema owner is the exclusive property of the creator of the schema 154.

Standard schema providers create standard schemas 166 that are intended to be public standards. While a standard schema 166 is defined, managed, and owned by its creator, it is intended for public use and for open interoperation with third party systems. Standard schemas 166 stand alone and are not linked to specific devices, private schemas, or app providers. However, a manufacturer may define a standard schema 166, in which case the manufacturer's account 140 is linked to the standard schema provider account 164.

User accounts 156 are owned by users (i.e., public individuals). Access to a user account 156 is managed via email/password/Mobile Directory Number (MDN, i.e., phone number) credentials 160. A user account 156 may be linked with one or more generic third party accounts such as FACEBOOK®, TWITTER®, and the like, IoT user accounts in manufacturer cloud servers 102, such as GARMIN®, FITBIT®, HONEYWELL®, GE®, TESLA®, and the like, and/or user accounts on third party app sites such as TRAININGPEAKS®, a device-independent triathlon training dashboard and data consolidation site.

A user account 156 may be linked to one or more devices 162. For example, a user may own a FITBIT® fitness band, a GARMIN® running watch, and a NEST® thermometer. The user may disclose their devices 162 to the IoT hub by, for example, disclosing the user credentials 160 (i.e., in the above example, GARMIN® login credentials, FITBIT® login credentials, and NEST® login credentials). The credentials 160 enable the IoT hub to retrieves device information directly from the manufacturer's servers 102. App provider accounts 168 are accounts for manufacturers and/or third party app providers who develop apps required to cross-reference a user's devices 162 registered on the manufacturer's cloud server 102 with the manufacturer's devices 144 disclosed and stored in the IoT hub 106.

An app provider may be a developer of a translator app, a developer of an app that performs data manipulation, experimentation, and analysis, or a developer of an app that aggregates data on a dashboard. A translator app developer develops translators between two schemas. Each translator app is stored in the IoT open system data hub 106 as a separate translator app linking to two schemas, where each schema could be a private, public, and/or standard schema. For example, “XYZ Translator Company” may create an app developer account. The app developer may create a “Garmin Forerunner to Public ISO Fitness Schema 123” translator app, a one-way translator that only converts from Garmin Forerunner devices to a publicly defined standard schema named the “Public ISO Fitness Schema 123”. The translator may convert units as necessary and may be listed or queriable for use when a user wishes to convert Garmin Forerunner device data to the Public ISO Fitness Schema 123. Each app has a star rating and public comments, and may have a price attached (e.g., free trial, single use, fixed # of uses, fixed time period, unlimited license, and the like).

A developer of an app that performs data manipulation, experimentation, and analysis may manipulate data to consolidate, translate, and analyze data. Examples of such apps include, but are not limited to, a data compression app that may compress second-by-second heart rate measurements while eliminating duplicated data points. A data mining app may determine that a user's running performance degrades by exactly 5% per hour of lost sleep two nights before the race, that a cyclist's performance drops drastically when the outside temperature is over 80 degrees, that a diabetic needs to walk at least 1 mile per day to control his or her blood sugar without insulin, and/or finding the thermostat settings that maximize a person's sleep quality while minimizing their heating and cooling costs. These apps may also create data sets, for example, extracting a cyclist's cadence vs. incline over a 12 month period into a separate data set for reporting. These apps may consume one or more schemas. If a user's data is not natively available in that schema, the user and/or app would need to find an appropriate translator.

App developers may also create dashboards, smartphone apps, web sites, etc. that consolidate, analyze, and present data to the user or third parties. For example, TRAININGPEAKS® and STRAVA® are dashboard apps, that consolidate, present, and analyze data; however these web sites depend on open manufacturer API's and/or private agreements with device manufacturers, rather than open, published schemas residing in an open IoT hub as described herein. These apps would consume one or more schemas. If a user's data is not natively available in that schema, the user and/or app would need to find an appropriate translator app.

An app provider account 168 is created for each third party developer that creates an app for use on the Open System IoT Data Hub 106. Apps, for example, include schema translation apps, data access and reporting apps, data synchronization apps, security administration apps, data monitoring apps, widgets, websites, dashboards, and the like. For each account, there are services provided to the account holder including, but not limited to a billing system, accounting for purchases and sales, a marketplace for apps (e.g., App Stores, eLance, eBay®, and the like), a rating system for the apps (e.g. user reviews, a “star” system), and the like.

The data storage and management system 170 includes a device database 172, data storage 182, at least one translator app 184, an authorization module 186, a data manager 188, a device data access module 190, and a request engine 192. The device database 172 includes all of the devices from all manufacturers that are monitored by the Open System IoT Data Hub 106. Each device 174 includes a device identifier 176, a device type 178, and a device manufacturer 180. The translator apps 184, authorization module 186, data manager 188, device data access module 190, and request engine 192 each comprises a set of instructions residing in memory 134 and executable by a Central Processing Unit (CPU) 130. The data storage 182 is a NoSQL Storage of IoT Device Data.

The data storage 182 is partitioned by end user account, generating device, schema, security classification, date/timestamp, user, and defined tags. The user account is the end user whose data is being aggregated. The generating device is the specific device, including device type, manufacturer, and firmware version that generated said data. The one or more schema is the schema, whether public, private, and/or public standard, in which the data resides. In some embodiments, security classifications default to “PRIVATE” such that the user data is only accessible by the user. A user may choose to expose this data to others using a standard permission scheme such as sharing with FACEBOOK® friends, sharing with a list of IOT Hub users, sharing with a list of IOT manufacturers, sharing via email, for example, as an attachment or with a link to an IOT data hub website. A Date/Timestamp identifies an exact date and timestamp upon which the data was generated. For example, fitness tracking data from a 5K run may have the date and timestamp for when the run started and ended. Users may add their own fields or classifications. For example, a user may enter a House Address/GPS location/house nickname. If a user has 10 rental properties and 10 smart thermostats the user might add a field to tag which address or property is associated with the data. In another example, if a user has multiple bicycles, the user may add a field tagging which bike the user rode for each ride. A construction contractor with a fleet of heavy equipment might identify which piece of heavy equipment generated specific data and which person or people were operating the heavy equipment at the time the data was generated. A heating, ventilation and air conditioning (HVAC) operator might add remote airflow and temperature sensors into multiple vents in an office building, and tag the data indicating in which vent or duct the data was measured.

The data is owned by the account that created or provided it (e.g., manufacturer, user, app developer, schema owner, and the like), and is exposed or shared according to owner-defined permissions. Manufacturers may provide global read access for all of the manufacturer's devices. Access may be hierarchical and granular, so, for example, a fitness user may grant read access to all of the user's workouts to his or her coach. The user may also grant read access to fitness data from a specific triathlon to the user's close FACEBOOK friends.

Access to apps may be controlled by the app provider in conjunction with a marketplace—for example, all users can access app “A” for free, users can access app “B” for $0.99 per month, or a $1.99 one-time fee, or a $0.50 per use fee, and the like.

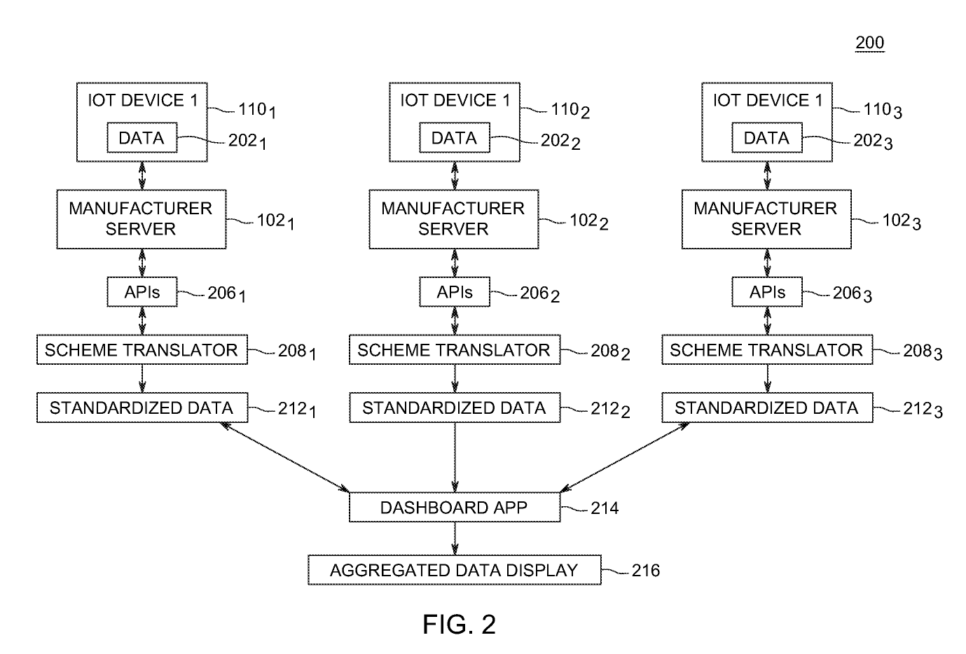

The interactions between the components of FIG. 1 are described by way of example in FIG. 2 below.

FIG. 2 is a block diagram 200 depicting an exemplary embodiment of an Open System IoT Data Hub 106, according to one or more embodiments of the invention. FIG. 2 includes three manufacturer cloud servers 102. In the present example, device manufacturer cloud server 102₁ is a GARMIN® cloud server, the device manufacturer cloud server 102₂ is a Bicycle Power Meter cloud server, and the device manufacturer cloud server 102₃ is a MYFITNESSPAL® server for a Calorie Counter & Diet Tracker app. In the present example, the GARMIN® cloud server 102₁ receives data 202₁ from a GARMIN® Vivofit Fitness Band 110₁. The Bicycle Power Meter cloud server 102₂ receives data 202₂ from a user's smartphone 110₁, which records cadence data from the accelerometers on the smartphone. The MYFITNESSPAL® cloud server 102₃ receives data 202₃ entered into an app on the user's smartphone 110₃.

In order to store the user's data, the user's credentials 160 are used by the authorization module 186 to gain access to the user's data on each manufacturer cloud server 102. Once authorized, the device data access module 190 determines which devices 162 are associated with the user account 156 and uses APIs 206 to request data 202 from each of the cloud servers 102 associated with each device 162. The schema translator 208₁ performs schema mapping by comparing the closed schema 148 in which the data 202₁ was received and the standard schema 166 in which the data 202₁ should be stored. If the data 202₁ received from the cloud server 102 does not conform to the standard schema 166, the schema translator 208₁ converts the data 202₁ received from the cloud server 102₁ into standardized data 212₁, including performing any required unit conversions. Similarly, schema translators 208₂ and 208₃ convert the data 202₂ and 202₃ from each device 110₂ and 110₃, respectively. The data manager 188 stores the converted standardized data 212 in data storage 182. In some embodiments, the data storage 182 is synchronized with each cloud server 102 periodically. In some embodiments, the data storage 182 is synchronized with the cloud server 102 on demand. In some embodiments, the data storage 182 is synchronized with the cloud server 102 when the cloud server 102 sends a notification to the Open System IoT Data Hub 106 that new data is available. In alternate embodiments, the communication and synchronization may occur upon connectivity, upon resource availability, upon reaching pre-defined data thresholds, and the like.

When a user launches an app that requires the data in data storage 182, for example, dashboard app 214 that aggregates data from a plurality of IoT devices 110, the request engine 192 queries the data storage 182 to retrieve specific data elements from each of the plurality of IoT devices 110 for the user. In some embodiments, the data in data storage 182 is synchronized with the data on the manufacturer cloud servers 102 before the request engine 192 retrieves the data from the data storage 182. The data in the data storage 182 has been converted and is in a standard form usable by any specific data elements may be retrieved and aggregated as needed by the application for display 216 to the user.

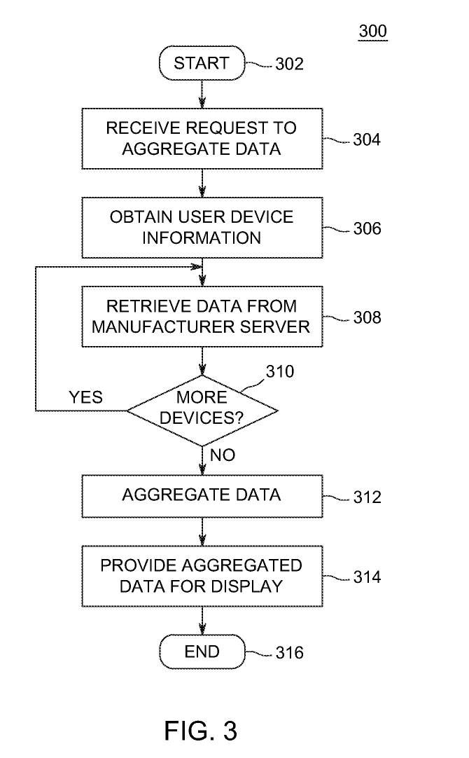

FIG. 3 is a flow diagram depicting a method 300 for storing and accessing data in an open system IoT data hub, in accordance with one or more embodiments of the present invention. The method 300 starts at step 302 and proceeds to step 304.

At step 304, a request is received to aggregate data from two or more IoT device manufacturers. The IoT devices may be any physical device, vehicle, or other items embedded with electronics, software, sensors, and network connectivity that enable these items to collect and exchange data. The device may be a smartphone with two or more apps that have collected data.

At step 306, the manufacturer servers from which the data is to be retrieved are determined. Each of the devices and/or apps may be manufactured by a different manufacturer, and the data from each is stored on the manufacturer server. Each manufacturer stores its data according to its own proprietary data schema.

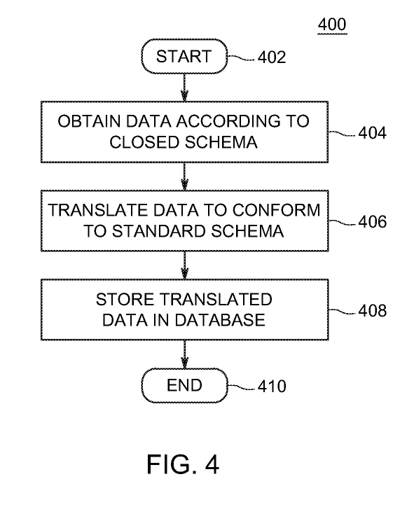

At step 308, the data is retrieved from a server of a manufacturer, as described in more detail with respect to FIG. 4 below.

At step 310, it is determined whether there are additional servers from where data must be retrieved. If at step 310, it is determined that data must be retrieved from additional manufacturer servers, then the method proceeds to step 308 and iterates until it is determined at step 310, that no data must be retrieved from additional manufacturer servers, at which time the method proceeds to step 312.

At step 312, the data retrieved from the manufacturer servers and stored in data storage is aggregated. The data is stored using a standard schema. In other words, the data elements and structure are in conformity with the standard. As such the data may be aggregated without regard to the specific data schema of the manufacturer. Rather, the data may be retrieved by any application that can extract data according to the standard schema.

At step 314, the retrieved data is provided for display. As such, the data retrieved from each of a user's devices may be retrieved from the plurality of manufacturers' servers, transformed and stored in such a way that it can be aggregated to provide the user with a global view of all of his or her data. The method 300 ends at step 316.

FIG. 4 depicts a flow diagram of a method 400 for retrieving data according to a closed schema and storing the data in a standardized form, according to one or more embodiments. The method 400 starts at step 402, and proceeds to step 404.

At step 404, data is obtained according to a closed schema. The data includes information that was received from an Internet of Things (IoT) device and stored on a server of the device manufacturer. In some embodiments, the data is obtained via open APIs from a manufacturer server. The APIs use data formats commonly known to those skilled in the art, for example JavaScript Object Notation (JSON), Extensible Markup Language (XML), and the like to transfer the data from the device manufacturer server to the IoT data hub. The data may be structured according to a proprietary schema defined by the manufacturer. The manufacturer may provide the closed schema to the IoT data hub such that translators may be written, and the data may be translated for use by other applications.

At step 406, the obtained data is translated into a standard schema. In some embodiments, the standard schema may be defined by an international governing body for the device. For example, the International Thermostat Manufacturers may define a standard schema for reading from and/or writing to a thermostat. The obtained data elements may be converted using a translation application specifically designed for converting the data obtained from a specific manufacturer or a specific device into the standard schema.

At step 408, the translated data is stored in a database. In some embodiments, the data is stored in an indexed redundant hierarchical NoSQL database. NoSQL storage is a commodity cloud resource, well known by those skilled in the art. As an example, data stored for a running workout may be stored in a GARMIN® system may be stored as follows. Only two data points are shown for brevity.

```
<Device>Forerunner 920XT</Device>
<DeviceID>512634897126390857126</DeviceID>
<DataPoint>
  <Timestamp>1:00:00PM</Timestamp>
  <HeartRate>165</HeartRate>
  <Speed>9Mph</Speed>
  <Cadence>182</Cadence>
  <Temperature>78DegreesF</Temperature>
  <LeftRightBalance>51%</ LeftRightBalance >
</DataPoint>
<DataPoint>
  <Timestamp>1:00:05PM</Timestamp>
  <HeartRate>164</HeartRate>
  <Speed>9.1Mph</Speed>
  <Cadence>181</Cadence>
  <Temperature>78DegreesF</Temperature>
  <LeftRightBalance>50%</ LeftRightBalance >
</DataPoint>
```

When GARMIN® provides access, this data may be imported to the IoT Hub in Garmin's native format. It may be staged (i.e., stored temporarily for processing) in a NoSQL database, using the GARMIN® FORERUNNER® Native Schema. In the present example, it is assumed that GARMIN® has a single schema for all FORERUNNER® devices; however, in reality, there may be a different schema for each of their devices.

### Timestamp: 1:00:00 PM

### User: John Doe

### Device: Garmin Forerunner 920XT

### Security: Private

### Schema: Garmin Forerunner

In the NoSQL format, each of the above dimensions may be stored as a separate field and indexed such that each dimension may be looked up by any field or any combination of fields. Garmin may also define an “unpacked” NoSQL native format and a translator from their native format to the NoSQL unpacked format. Once the workout data is staged, the XML payload may be unpacked. Instead of one record for the whole workout, this second schema below contains one record per data point, in preparation for consumption by IoT apps:

### NoSQL Record #1

### Dimensions:

### Timestamp: 1:00:00 PM

### User: John Doe

### Device: Garmin Forerunner 920XT

### Security: Private

### Schema: Garmin Forerunner

### Data:

### Heart Rate: 165

### Speed: 9 Mph

### Cadence: 182

### Temperature: 78 Degrees F

### LeftRightBalance: 51° A

### NoSQL Record #2

### Dimensions:

### Timestamp: 1:00:05 PM

### User: John Doe

### Device: Garmin Forerunner 920XT

### Security: Private

### Schema: Garmin Forerunner

### Data:

### Heart Rate: 164

### Speed: 9.1 Mph

### Cadence: 181

### Temperature: 78 Degrees F

### LeftRightBalance: 50%

. . . (Many more records would exist for each timestamp in the file)

Continuing with the present example, assume that an ISO Running Fitness Format standard public schema exists. The standard public schema uses Celsius instead of Fahrenheit and pace (time per km) rather than Mph. The schema also calls “LeftRightBalance” by a different name. Assume that XYZ Translator Company provides a translator app to translate from the Garmin Unpacked NoSQL native format to the ISO Running Fitness format. Said translator app converts this data to:

### NoSQL Record #1

### Dimensions:

### Timestamp: 1:00:00 PM

### User: John Doe

### Device: Garmin Forerunner 920XT

### Security: Private

### Schema: Garmin Forerunner

### Data:

### Heart Rate: 165

### Speed: 4:08 per Km

### Cadence: 182

### Temperature: 25.6 Degrees C

### StrideSymmetry: 51° A

### NoSQL Record #2

### Dimensions:

### Timestamp: 1:00:05 PM

### User: John Doe

### Device: Garmin Forerunner 920XT

### Security: Private

### Schema: Garmin Forerunner

### Data:

### Heart Rate: 164

### Speed: 4:05 per Km

### Cadence: 181

### Temperature: 25.6 Degrees C

### StrideSymmetry: 50%

As such, in order to consolidate the data, a developer must understand each manufacturer's schema, access each manufacturer's device(s) and/or system(s) via the user's credentials, translate each manufacturer's data schemas into his or her own unified schema, convert units as necessary, (miles to km, pounds to kg, etc.), and make judgements regarding which data source(s) to use when data is present in multiple forms. For example, a bicycle racer wears a wrist-based fitness tracker and also users a handlebar-mounted computer on a bicycle ride. Both devices calculate speed and altitude using a wheel-mounted rotation counter, internal GPS, and internal barometers. When consolidating this data, four sources of speed are stored (wheel speed recorded by watch, wheel speed recorded by handlebar computer, GPS recorded by watch, and GPS recorded by handlebar computer). Likewise, four sources of altitude (watch barometer, handlebar barometer, watch GPS, handlebar GPS) are stored. The app developer determines the highest quality data source to aggregate into the dashboard. The method 400 ends at step 410.

FIG. 5 is a detailed block diagram of a computer system 500 that can be utilized in various embodiments of the present invention to implement the computer and/or the display devices, according to one or more embodiments.

Various embodiments of the present method and apparatus, as described herein, may be executed on one or more computer systems, which may interact with various other devices. One such computer system is computer system 500 illustrated by FIG. 5, which may in various embodiments implement any of the elements or functionality illustrated in FIGS. 1-4. In various embodiments, computer system 500 may be configured to implement methods described above. The computer system 500 may be used to implement any other system, device, element, functionality or method of the above-described embodiments. In the illustrated embodiments, computer system 500 may be configured to implement method 300 (FIG. 3), and method 400 (FIG. 4) as processor-executable executable program instructions 522 (e.g., program instructions executable by processor(s) 510) in various embodiments.

In the illustrated embodiment, computer system 500 includes one or more processors 510a-510n, collectively processor 510, coupled to a system memory 520 via an input/output (I/O) interface 530. Computer system 500 further includes a network interface 540 coupled to I/O interface 530, and one or more input/output devices 550, such as cursor control device 560, keyboard 570, and display(s) 580. In various embodiments, any of the components may be utilized by the system to receive user input described above. In various embodiments, a user interface may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, or netbook computer, mainframe computer system, handheld computer, workstation, network computer, a set top box, a mobile device such as a smartphone or PDA, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510 may be any suitable processor capable of executing instructions. For example, in various embodiments processors 510 may be general-purpose or embedded processors implementing any of a variety of instruction set architectures (ISAs). In multiprocessor systems, each of processors 510 may commonly, but not necessarily, implement the same ISA.

System memory 520 may be configured to store program instructions 522 and/or data 532 accessible by processor 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more display devices (not shown), or one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 550 may, in some embodiments, include one or more communication terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

In some embodiments, the illustrated computer system may implement any of the methods described above, such as the methods illustrated by the flowcharts of FIG. 3 and FIG. 4. In other embodiments, different elements and data may be included.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A method for storing and accessing data in an open system Internet of Things (IoT) data hub comprising:
receiving a request to aggregate data from at least a first device and a second device;
obtaining data from the first device according to a first closed data schema, wherein the obtained data comprises one or more data elements;
identifying a standard data schema defined for a device type of the first device;
executing a first set of instructions to translate the obtained data from the first device to be in conformity to the identified standard schema;
storing the translated data from the first device in a data structure in a memory;
obtaining data from the second device according to a second closed data schema;
identifying a standard data schema defined for a device type of the second device;
executing a second set of instructions to translate the obtained data from the second device to be in conformity to the identified standard schema;
storing the translated data from the second device in the data structure in the memory;
retrieving a plurality of elements from the data structure, wherein at least one element from the plurality of elements was obtained from the data obtained from the first device and at least one element from the plurality of elements was obtained from the data obtained from the second device;
executing a set of instructions to aggregate the retrieved plurality of elements; and
providing the aggregated elements for display.

2. The method of claim 1, wherein the first closed data schema is different from the second closed data schema.

3. The method of claim 1, wherein the first device and the second device each comprise a manufacturer server that stores user data retrieved from one of a manufacturer application or a manufacturer device.

4. The method of claim 3, wherein the obtained data is retrieved via an open application programming interface, said data stored according to the closed schemes.

5. The method of claim 1, wherein the first closed data schema and the second closed data schema are proprietary schemes defined by a first device manufacturer and a second device manufacturer.

6. The method of claim 1, wherein the standard schema is specific to a device type.

7. The method of claim 1, wherein the standard schema is defined by a governing body of an industry associated with the device.

8. The method of claim 1, wherein the data structure is an indexed redundant hierarchical NoSQL database.

9. The method of claim 1, further comprising securing the translated data in the data structure.

10. An open system IoT data hub, comprising:
a) at least one processor;
b) at least one input device; and
c) at least one storage device storing processor-executable instructions which, when executed by the at least one processor, perform a method including:
receiving a request to aggregate data from at least a first device and a second device;
obtaining data from the first device according to a first closed data schema, wherein the obtained data comprises one or more data elements;
identifying a standard data schema defined for a device type of the first device;
executing a first set of instructions to translate the obtained data from the first device to be in conformity to the identified standard schema;
storing the translated data from the first device in a data structure in a memory;
obtaining data from the second device according to a second closed data schema;
identifying a standard data schema defined for a device type of the second device;
executing a second set of instructions to translate the obtained data from the second device to be in conformity to the identified standard schema;
storing the translated data from the second device in the data structure in the memory;
retrieving a plurality of elements from the data structure, wherein at least one element from the plurality of elements was obtained from the data obtained from the first device and at least one element from the plurality of elements was obtained from the data obtained from the second device;
executing a set of instructions to aggregate the retrieved plurality of elements; and
providing the aggregated elements for display.

11. The open system of claim 10, wherein the first closed data schema is different from the second closed data schema.

12. The open system of claim 10, wherein the first device and the second device each comprise a manufacturer server that stores user data retrieved from one of a manufacturer application or a manufacturer device.

13. The open system of claim 12, wherein the obtained data is retrieved via an open application programming interface, said data stored according to the closed schema on the manufacturer server from one of a manufacturer application or a manufacturer device.

14. The open system of claim 10, wherein the first closed data schema and the second closed data schema are proprietary schemas defined by a first device manufacturer and a second device manufacturer.

15. The open system of claim 10, wherein the standard schema is specific to a device type.

16. The open system of claim 10, wherein the standard schema for each device is defined by a governing body of an industry associated with the device.

17. The open system of claim 10, wherein the data structure is an indexed redundant hierarchical NoSQL database.

18. The open system of claim 10, wherein the method further comprises securing the translated data in the data structure.
